(19) United States
(12) Patent Application Publication
(10) Pub. No.: US 2006/0017663 A1
(43) Pub. Date: Jan. 26, 2006

(54) Display module, drive method of display panel and display device

(76) Inventors: Yosuke Yamamoto, Tokyo (JP); Hisafumi Motoe, Saitama (JP); Satoshi Miura, Kanagawa (JP); Takeya Meguro, Tokyo (JP)

Correspondence Address: FROMMER LAWRENCE & HAUG LLP, 745 FIFTH AVENUE, NEW YORK, NY, 10151, US

(21) Appl. No.: 11/136,758

(22) Filed: May 25, 2005

(30) Foreign Application Priority Data
May 27, 2004 (JP) 2004-157937

(51) Int. Cl. G09G 3/20

(52) U.S. Cl. 345/75.2

(57) ABSTRACT

A flat display panel such as an FED panel is provided in which high display luminance is obtained with high picture quality and a simple wiring structure.

A display device includes a display panel in which column direction wirings 15 and row direction wirings 16 are formed perpendicularly to each other and the column direction wirings 15 are divided into N sets (N is an integer of 2 or more) in the vertical direction of a screen, drive elements 13, 18 which drive each of these N sets of the column direction wirings 15, a scanning element 14 which scans the row direction wirings 16, and an interpolation element 19 which performs flame-interpolation on an input video signal N times; wherein the scanning element 14 simultaneously scans the row direction wirings 16 corresponding to these N sets of the column direction wirings 15 respectively with approximately 1/N the vertical cycle of the video signal, and the drive elements 13, 18, to which an interpolated video signal from the interpolation element 19 is input, drive each of these N sets of the column direction wirings 15 by the interpolated video signal with a frame shifted by 1/N the vertical cycle of the input video signal.

### CROSS REFERENCES TO RELATED APPLICATIONS

The present invention contains subject matter related to Japanese Patent Application JP 2004-157937 filed in the Japanese Patent Office on May 27, 2004, the entire contents of which being incorporated herein by reference.

### BACKGROUND OF THE INVENTION

1. Field of the Invention

The present invention relates to a display module, a drive method of a display panel and a display device, and particularly to the ones suitably applied to an FED display device in which a field emission type cathode is used and to an organic electroluminescence display device or the like.

2. Description of the Related Art

Recently, as one of flat panel type displays used for a display device, for example, a display device in which a field emission type cathode is used is developed. As the display device in which the field emission type cathode is used, there is what is called a field emission display (hereinafter called an FED).

In the FED are obtained a number of characteristics such as a high grayscale display with the angle of view secured, high picture quality and production efficiency, high response speed, operation in the environment of very low temperature, high luminance, and high power efficiency. Further, the production process of an FED is simplified in comparison with that of an active matrix type liquid crystal display, and it is expected that the production cost be 40% to 60% lower than the active matrix type liquid crystal display.

FIG. 1 shows an example of a structure of an FED panel. In the FED panel, a cathode panel 35 and an anode panel 37 are faced with a gap in vacuum condition in between. The cathode panel 35 is formed such that a plurality of cathode electrodes 39 and a plurality of gate electrodes 311 are formed on a support body 313 perpendicularly to each other with an insulation layer 38 in between, and an electron emission region 312 is formed at each intersection of the cathode electrode 39 and the gate electrode 311.

On the other hand, the anode panel 37 is formed such that phosphor layers 31, 32 and 33 corresponding to R (red), G (green) and B (blue) of three primary colors of light are applied to a substrate 30 made of a transparent material and an anode electrode 36 made of a transparent material is formed to be a layer on the phosphor layers 31, 32 and 33. In this example, a black matrix 34 is formed between the phosphor layers 31, 32, 33 and the anode electrode 36.

FIG. 2 is a sectional view showing the inside structure of the electron emission region 312. A cathode electrode 21 (corresponding to the cathode electrode 39 in FIG. 1) is formed on a glass 25 (corresponding to the substrate 30 in FIG. 1); a gate electrode 20 (corresponding to the gate electrode 311 in FIG. 1) is formed on the cathode electrode 21 with a resistance 24 and an insulation layer 211 (corresponding to the insulation layer 38 in FIG. 1) in between. A plurality of openings that are shown as openings 310 in FIG. 1 are provided on the insulation layer 211 and gate electrode 20, and a cathode element (cold cathode) 22 corresponding to each opening is formed on the cathode electrode 21 to strengthen an electric field (only one opening and one cathode element 22 are illustrated in FIG. 2). The cathode element and cathode electrode are electrically connected. In other words, the field emission type cathode is formed of the cathode electrode 21 and the plurality of cathode elements 22.

As shown in FIG. 1, each electron emission region 312 is faced to one of the phosphor layers 31, 32 and 33 of the anode electrode 36, and three adjacent electron emission regions 312 respectively facing the phosphor layers 31, 32 and 33 correspond to one pixel.

Therefore, by applying voltage between the gate electrode 311 and the cathode electrode 39 of the electron emission region 312, electrons are emitted from the cathode elements 22 (FIG. 2) of the electron emission region 312, and by applying voltage between the anode electrode 36 of the anode panel 37 and the cathode electrode 39 of the electron emission region 312, the above electrons emitted are attracted to the side of the anode electrode 36, and these electrons collide with the phosphor layers 31, 32 and 33, whereby light is emitted from the phosphor layers 31, 32 and 33.

Next, the drive principle of a field emission type cathode used for the FED mentioned above is explained. In FIG. 2, by applying voltage Vcol to the cathode electrode 21 from a variable voltage source 210 and by applying voltage Vrow to the gate electrode 20 from a variable voltage source 29, and accordingly when the voltage difference expressed as Vgc is applied between the cathode electrode 21 and gate electrode 20, electrons are emitted from the cathode elements 22 by an electric field generated with the applied voltage. At this time, if voltage HV is applied to the anode electrode 27, electrons are attracted to the anode electrode 27 under the condition of
HV>Vrow (1)
and thereby anode current Ia flows to the cathode electrode 21 from the anode electrode 27 of FIG. 2. At this time, upon applying phosphors 26 (corresponding to phosphor layers 31, 32, and 33 in FIG. 1) to the anode electrode 27, the phosphors 26 emit light by energy of the above described electrons.

If voltage Vgc is changed, the amount of electrons emitted from the cathode elements 22 is changed, whereby anode current Ia is also changed. Further, the amount of light emitted from the phosphors 26, that is, light emission luminance L is proportional to anode current Ia and is expressed as follows.
L∝Ia (2)

Therefore, if the above voltage described Vgc is changed, the emitted light luminance L can be changed. Accordingly, the luminance can be modulated by modulating the voltage Vgc in accordance with the signal to be displayed.

FIG. 3 shows an example of a basic structure of an FED display system in which the above described FED panel is used. A support body 17 is a support body (corresponding to the support body 313 in FIG. 1) constituting a cathode panel of the FED panel. On the support body 17, a plurality of column direction wirings 15 and a plurality of row direction wirings 16 are formed, and gate electrodes, cathode electrodes and electron emission regions as shown in FIG. 1 exist at each intersection of the column direction wirings 15 and the row direction wirings 16 (although not shown in the figure, an anode panel is faced above the cathode panel as shown in FIG. 1).

An FED module is formed by connecting a column direction pixel drive voltage generator 13 and row direction drive pixel selecting voltage generator 14 to the column direction wirings 15 and row direction wirings 16 of this FED panel, respectively.

Further, the FED display system shown in FIG. 3 is an example in which an input video is of an analogue signal, and includes an A/D converter 10 that converts the analogue signal input to this FED panel display system into a digital signal, a video signal processor 11 to which the digital video signal from the A/D converter 10 is input and a control signal generator 12.

The row direction drive pixel selecting voltage generator 14 is provided to selectively apply a variable row direction selection voltage Vrow (refer to FIG. 2) to the row direction wirings 16 and, for example, 35V is applied when selected and 0V is applied when not selected.

The column direction pixel drive voltage generator 13 mainly includes, though not shown in the figure, a shift register for inputting the digital video signals (typically digital signals of R (Red), G (Green) and B (blue)) of one line (=one horizontal period), a line memory for retaining the above described digital video of one line period, a D/A converter in which the above one line video is converted into analogue voltage to be applied for one line period, and the like; and applies a variable column direction drive voltage Vcol (refer to FIG. 2) to the column direction wirings 15 simultaneously by one line.

For example, when the row direction selection voltage Vrow is selected, namely when 35V is applied, if the column direction drive voltage Vcol is 0V, the voltage difference between the gate and cathode becomes 35V, and the amount of electrons emitted from the cathode element 22 (refer to FIG. 2) increases, and the light emitted from the phosphors 26 (refer to FIG. 2) becomes high luminance. Further, similarly, when the row direction selection voltage Vrow is selected, namely when 35V is applied and if the column direction drive voltage Vcol is 15V, the voltage difference Vgc between the gate and cathode becomes 20V; however, because the electron emitted has the characteristic of emission as shown in FIG. 12 with respect to Vgc, electrons are not emitted when the Vgc is 20 v, consequently no light is emitted. Therefore, display with the desirable luminance can be performed by controlling the column direction drive voltage Vcol from 0V through 15V in accordance with the input video signal level.

In the case where a picture is displayed on the FED panel, the row direction wirings 16 are sequentially driven (scanned) by one line and synchronously, modulated signals of the picture of one line are applied to the column direction wirings 15 simultaneously, thereby controlling the irradiation amount of electron beams to the phosphors and displaying the picture by the line sequence.

The video signal processor 11 applies picture quality adjustment processing and matrix processing to the digital video signal from the A/D converter 10, outputs a digital signal of each 8-bit R, G and B, for example, and outputs a horizontal synchronous signal and vertical synchronous signal. The digital signal of R, G and B of is directly input to the column direction pixel drive voltage generator 13. Further, the horizontal synchronous signal and vertical synchronous signal are input to the control signal generator 12.

Based on the horizontal synchronous signal and vertical synchronous signal, the control signal generator 12 generates a column wiring drive circuit video acquisition start pulse that indicates the video acquisition start timing in the column direction pixel drive voltage generator 13, and a column wiring drive start pulse that indicates the analogue video voltage generation timing in the D/A converter within the column direction pixel drive voltage generator 13.

Further, based on the horizontal synchronous signal and vertical synchronous signal, the control signal generator 12 generates a row wiring drive start pulse that indicates the drive start timing of row direction wiring drive voltage in the row direction drive pixel selecting voltage generator 14, and a row wiring selection shift clock that is a reference shift clock for sequentially driving the row direction wirings 16 by one line from the top.

FIG. 4 shows the drive timing of the FED panel in the FED panel display system of FIG. 3. The column wiring drive circuit video input is the R, G and B digital signal of 8-bit each and 24 bits in total, for example, input in parallel to the column direction pixel drive voltage generator 13 (refer to FIG. 3), and though not shown in this figure, one pixel is sampled by a reference dot clock for digital video signal reproduction.

The column direction pixel drive voltage generator 13 detects the above described column wiring drive circuit video acquisition start pulse immediately before column wiring drive circuit video input (before one dot clock, for example) and, after that, the column wiring drive circuit video input is acquired into the line shift register that sequentially stores pixels of one horizontal line synchronously with the dot clock. Further, synchronizing with the above described column wiring drive start pulse detected after completing the acquisition of pixels for one line, the one-line video data is transferred to a line memory, and the held video data of one line is simultaneously D/A converted by one pixel to be output as the column wiring drive voltage of analog voltage, for example. In FIG. 4, the column wiring drive voltage for driving the Ath pixel in the horizontal direction is representatively shown as the Ath column wiring drive voltage, for example.

The row direction drive pixel selecting voltage generator 14 detects the ON state of the above described row wiring drive start pulse, for example, on the rising edge of the row wiring drive start pulse, and with the rising edge as a reference point, lines from the first row through the last row are sequentially driven (scanned) by one line synchronously with the row wiring selection shift clock.

With such timing, the above described voltage Vgc that is the difference voltage between the row wiring drive voltage and the column wiring drive voltage is applied between the gate and cathode, the irradiation amount of electron beams to the phosphors is controlled, and a picture is displayed by one line by means of the line sequential driving. At this time, the light emission time per line is determined by the horizontal cycle of an input video signal.

However, in such line sequential driving, if the higher resolution with an increased number of pixels of a panel and the enlargement to obtain a large screen display are attempted in the future, there occurs such a problem of decline in luminance caused by decrease in light emission time per line due to the decrease in the horizontal cycle of a video signal.

For example, in the case of 800×600 pixels (typically called SVGA resolution), one horizontal cycle is 26.4 μsec; and in the case of 1920×1080 video signal (typically called HD resolution), one horizontal cycle becomes 14.4 μsec, and the light emission time is decreased inversely proportional to the increase of the vertical line number, such as 14.4/26.4 nearly equals to 0.545, and the luminance decreases by the same magnification. Therefore, it is necessary to compensate with some sort of method the decrease in luminance of light emitted due to the higher resolution of the panel.

### SUMMARY OF THE INVENTION

The compensation methods of related art are roughly classified into:
(a) a method in which luminance of light emitted for one horizontal cycle increases to improve the luminance of light emitted, and
(b) a method in which the light emission time is extended more than one horizontal cycle to improve the luminance of light emitted.

In those methods, although the method (a) can be obtained by increasing the emission current density with respect to the phosphor of a panel light emission element per horizontal cycle in the above described driving principle, it may be difficult to obtain with ease the substantial improvement only with this method in light of the luminance saturation problem of phosphors.

Therefore, the method (b) has been employed in addition to the method (a) in related art; the method (b) is roughly classified into the following two methods according to the structure of column direction wirings of an FED panel:
(c) a method in which the column direction wirings are divided in the vertical direction to be connected to the cathode electrodes, and
(d) a method in which the column direction wiring number is doubled in the horizontal direction to be alternately connected to the cathode electrode of each row (refer to, for example, Patent document 1: Published Japanese Patent Application 2002-123210 (paragraphs No. 0014 to 0018, FIG. 3)).

In the method (c), as shown in FIG. 11A, the column direction wirings divided in the vertical direction are separated at the center of a panel to be controlled by individual top and bottom column direction drive means. A method in related art of extending the light emission time by using the method (c) is explained.

First, for comparison, the typical scanning timing of the FED panel shown in FIG. 3 is shown in FIG. 5. This figure shows that the light emission time per line is one horizontal cycle (=1H) in typical display, and that scanning is performed by one line (=1H) from the topmost line.

Next, FIG. 6 shows an example of the scanning timing of the FED panel in the case where the column direction wirings are divided in the vertical direction as described in the method (c) In this example of scanning timing, the light emission time per line is extended to twice the horizontal cycle (=2H), and the upper and lower row wirings and the upper and lower column wirings of corresponding pixels are scanned simultaneously, thereby performing the display of one screen with twice the light emission time within one vertical cycle.

However, in this case, when the moving picture is being watched at the center portion of a screen (boundary of the top and bottom screens) where the wirings are divided in the vertical direction, there is a problem of feeling the discontinuity. The discontinuity is caused by the discordance in the scanning order in one vertical cycle of the video signal.

Hence, in order to solve this problem, a drive method of scanning timing shown in FIG. 7 in which the discontinuity of scanning order at the boundary of the top and bottom is improved has been proposed. This drive method is the same as that of FIG. 6 in which the light emission time is extended to 2H and the top and bottom are simultaneously scanned; and in addition to this, the scanning order of the bottom side screen is delayed by one frame, in order to eliminate the discontinuity of scanning order occurred at the boundary of the top and bottom. Therefore, the continuity of scanning order at the boundary of the top and bottom is provided. With such driving as described above, the feeling of discontinuity of moving picture in the center of screen disappears certainly.

However, in the case of this drive method, as is understood from FIG. 7, the video vertical cycle that scans one screen becomes 1/30 sec that is twice the typical video signal (one cycle= 1/60). If the scanning is performed with such timing, with the moving picture of an object which, for example, horizontally moves from the left side to right side on the screen, there occurs more screen distortion than in typical scanning, as shown in FIG. 10, and the display becomes unnatural, which is a problem.

Next, the above method (d) is explained in which the panel column wirings are doubled in the horizontal direction to be alternately wired to each row. As shown in FIG. 11B, in this method, the drive of one column is performed by two column direction wirings, and these two column direction wirings are wired to even rows and odd rows respectively, in which the even rows and odd rows can independently be scanned to emit light respectively. With such wiring structure, the scanning can be performed with the timing controlled as shown in FIG. 8, for example.

In this case, a problem regarding picture quality can be reduced and the luminance can be improved, however, this wiring structure in which the panel column wirings are doubled in the horizontal direction had a problem of making an actual panel design physically difficult.

As described above, in a flat display panel such as an FED panel, it is desired to obtain favorable display luminance using a simple wiring structure without impairing the picture quality.

A display module according to an embodiment of the present invention includes: a display panel in which column direction wirings and row direction wirings are formed perpendicularly to each other and the column direction wirings are divided into N sets (N is an integer of 2 or more) in the vertical direction of a screen, drive means for driving these N sets of the column direction wirings, and scanning means for scanning the row direction wirings; wherein the scanning means simultaneously scan the row direction wirings respectively corresponding to these N sets of the column direction wirings with approximately 1/N the vertical cycle of a video signal, and the drive means, to which an interpolated video signal that is the video signal frame-interpolated N times is input, drive each of these N sets of the column direction wirings by the interpolated video signal with a frame shifted by 1/N the vertical cycle of the video signal.

In this display module, the display panel has the wiring structure in which the column direction wirings are divided in the vertical direction. Further, the scanning means simultaneously scan the row direction wirings corresponding to the N sets of column direction wirings divided in the vertical direction respectively with approximately 1/N the vertical cycle of the video signal. Further, the drive means, to which an interpolated video signal that is the video signal frame-interpolated N times is input, drive each of the N sets of the column direction wirings by the interpolated video signal with a frame shifted by a 1/N vertical cycle of the video signal.

As described above, since the row direction wirings respectively corresponding to the N sets of column direction wirings divided in the vertical direction are simultaneously scanned with approximately 1/N the vertical cycle of the video signal, the video scanning cycle of each line becomes 1/N the cycle of the original video signal. However, because the display period per line in the video signal scanning remains the same horizontal period (1H) of the original video signal, the light emission of 1H occurs N times when converted into the vertical scanning period of the input video signal, which is equivalent to the light emission time extending to N times, and the luminance becomes N times high in comparison with the typical scanning timing (refer to FIGS. 4 and 5).

Further, with respect to the picture quality, because the video scanning cycle for one screen corresponds with the vertical scanning period of the original video signal (an interpolated video signal by each frame is displayed on the screen in each vertical cycle of the original video signal), such considerable distortion (refer to FIG. 10) as caused by the drive method of related art shown in FIG. 7 due to the mismatch between the input video cycle and the display timing cycle is prevented from occurring on the screen. Further, because the N sets of column direction wirings divided are driven by the interpolated video signal with a frame shifted by 1/N the vertical cycle of the original video signal, the feeling of discontinuity in the center of the screen does not occur when the moving picture is displayed by a drive method of related art as shown in FIG. 6. Therefore, it becomes possible to display video of high picture quality.

Further, with respect to the wiring structure of a panel, since the column direction wirings are divided in the vertical direction, the panel design becomes physically easy in comparison with the case where the panel column wirings are doubled in the horizontal direction, as shown in FIG. 11B.

Further, in this display module, as an example, the column direction wiring may be divided in two, that is, the top and bottom. In this case, the luminance can be made twice the typical scanning timing.

Alternatively, the column direction wiring may be divided into three or more in the vertical direction, and column direction wirings other than those at the top end and bottom end of the screen and the drive means may be wired on the rear side of the display panel. In this case, luminance can be made three times the typical scanning timing.

Next, a drive method of a display panel according to an embodiment of the present invention, in which the column direction wirings and row direction wirings are formed perpendicularly to each other and the column direction wirings are divided into N sets (N is an integer of 2 or more) in the vertical direction of a screen, includes the steps of: generating an interpolated video signal that is a video signal frame-interpolated N times, simultaneously scanning the row direction wirings respectively corresponding to the N sets of column direction wirings with approximately 1/N the vertical cycle of the video signal, and driving each of the N sets of the column direction wirings by an interpolated video signal with a frame shifted by a 1/N vertical cycle of the video signal among the N times frame-interpolated video signals of the video signal.

According to this drive method, the row direction wirings respectively corresponding to the N sets of column direction wirings divided in the vertical direction are simultaneously scanned with approximately 1/N the vertical cycle of the video signal. Further, each of the N sets of the column direction wirings is driven by the interpolated video signal with a frame shifted by a 1/N vertical cycle of the video signal among the N times frame-interpolated video signals of this video signal.

As described above, since the row direction wirings respectively corresponding to the N sets of column direction wirings divided in the vertical direction are simultaneously scanned with approximately 1/N the vertical cycle of the video signal, the video scanning cycle of each line becomes 1/N the cycle of the original video signal. However, because the display period per video signal scanning line remains the same horizontal period (1H) of the original video signal, the light emission of 1H occurs N times when converted into the vertical scanning period of the input video signal, which is equivalent to the light emission time extending to N times, and the luminance becomes N times the typical scanning timing (refer to FIGS. 4 and 5).

Further, with respect to the picture quality, because the video scanning cycle for one screen corresponds with the vertical scanning period of the original video signal (an interpolated video signal by each frame is displayed on the screen in each vertical cycle of the original video signal), such considerable distortion (refer to FIG. 10) as caused by the drive method of related art shown in FIG. 7 due to the mismatch between the input video cycle and the display timing cycle is prevented from occurring on the screen. Further, because the N sets of column direction wirings divided are driven by the interpolated video signal with a frame shifted by 1/N the vertical cycle of the original video signal, the feeling of discontinuity in the center of the screen does not occur when the moving picture is displayed by a drive method of related art as shown in FIG. 6. Therefore, it becomes possible to display video of high picture quality.

Further, with respect to the wiring structure of a panel, since the column direction wirings are divided in the vertical direction, the panel design becomes physically easy in comparison with the case where the panel column wirings are doubled in the horizontal direction, as shown in FIG. 11B.

Next, a display device according an embodiment of the present invention includes: a display panel in which column direction wirings and row direction wirings are formed perpendicularly to each other and the column direction wirings are divided into N sets (N is an integer of 2 or more) in the vertical direction of a screen, drive means for driving these N sets of the column direction wirings, scanning means for scanning the row direction wirings, and interpolation means for interpolating a frame of an input video signal N times; wherein the scanning means simultaneously scans the row direction wirings respectively corresponding to these N sets of the column direction wirings with approximately 1/N the vertical cycle of the input video signal, and the drive means, to which an interpolated video signal from the interpolation means is input, drive each of these N sets of the column direction wirings by the interpolated video signal with a frame shifted by a 1/N vertical cycle of the video signal.

In this display device, the display panel has the wiring structure in which the column direction wirings are divided in the vertical direction. Further, the scanning means simultaneously scan the row direction wirings respectively corresponding to the N sets of column direction wirings divided in the vertical direction with approximately 1/N the vertical cycle of the video signal. Further, the input video signal is frame-interpolated N times by the interpolation means. Further, the drive means, to which an interpolated video signal from the interpolation means is input, drive each of the N sets of the column direction wirings by the interpolated video signal with a frame shifted by a 1/N vertical cycle of the input video signal.

As described above, since the row direction wirings respectively corresponding to the N sets of column direction wirings divided in the vertical direction are simultaneously scanned with approximately 1/N the vertical cycle of the video signal, the video scanning cycle of each line becomes 1/N the cycle of the original video signal. However, because the display period per video signal scanning line remains the same horizontal period (1H) of the original video signal, the light emission of 1H occurs N times when converted into the vertical scanning period of the input video signal, which is equivalent to the light emission time extending to N times, and the luminance becomes N times the typical scanning timing (refer to FIGS. 4 and 5).

Further, with respect to the picture quality, because the video scanning cycle for one screen corresponds with the vertical scanning period of the original video signal (an interpolated video signal by each frame is displayed on the screen in each vertical cycle of the original video signal), such considerable distortion (refer to FIG. 10) as caused by the drive method of related art shown in FIG. 7 due to the mismatch between the input video cycle and the display timing cycle is prevented from occurring on the screen. Further, because the N sets of column direction wirings divided are driven by the interpolated video signal with a frame shifted by 1/N the vertical cycle of the original video signal, the feeling of discontinuity in the center of the screen does not occur when the moving picture is displayed by a drive method of related art as shown in FIG. 6. Therefore, it becomes possible to display video of high picture quality.

Further, with respect to the wiring structure of a panel, since the column direction wirings are divided in the vertical direction, the panel design becomes physically easy in comparison with the case where the panel column wirings are doubled in the horizontal direction, as shown in FIG. 11B.

According to the embodiments described above, in the case where a flat display panel such as an FED panel or the like has high resolution and is large-sized, excellent display luminance with high picture quality can be obtained with a simple panel wiring structure.

### BRIEF DESCRIPTION OF THE DRAWINGS

These and other objects and features of the present invention will become clear from the following description of the preferred embodiments given with reference to the accompanying drawings, in which:

FIG. 1 is a view showing an example of a structure of an FED panel;

FIG. 2 is a view showing an inside structure of an electron emission region;

FIG. 3 is a diagram showing a basic structure of an FED panel display system;

FIG. 4 is a diagram showing a drive timing of the FED panel of FIG. 3;

FIG. 5 is a diagram showing a scanning timing of the FED panel of FIG. 3;

FIG. 6 is a diagram showing an example of scanning timing of an FED panel of FIG. 11A;

FIG. 7 is a diagram showing an example of scanning timing of the FED panel of FIG. 11A;

FIG. 8 is a diagram showing an example of scanning timing of an FED panel of FIG. 11B;

FIG. 9 is a diagram showing an example of scanning timing of an FED panel of FIG. 13;

FIG. 10 is a view showing an example of distortion of moving picture in the scanning timing of FIG. 7;

FIGS. 11A and 11B are diagrams showing methods in related art of compensating the light emission luminance in an FED;

FIG. 12 is a characteristic curve showing an electron emission characteristic of a cathode element;

FIG. 13 is a diagram showing a structure of an FED panel display system according to an embodiment of the present invention;

FIGS. 14A and 14B are diagrams showing the scanning timing of the FED panel of FIG. 13;

FIG. 15 is a diagram showing a modified example of the column wiring structure of the FED panel of FIG. 13;

FIG. 16 is a diagram showing a scanning timing of the modified example of FIG. 15;

FIG. 17 is a diagram showing a modified example of the column wiring structure of the FED panel of FIG. 13;

FIG. 18 is a rear view of the FED panel of FIG. 17;

FIG. 19 is a sectional view of the FED panel of FIG. 17; and

FIG. 20 is a diagram showing a scanning timing of the FED panel in the modified examples of FIGS. 17 to 19.

### DESCRIPTION OF THE PREFERRED EMBODIMENTS

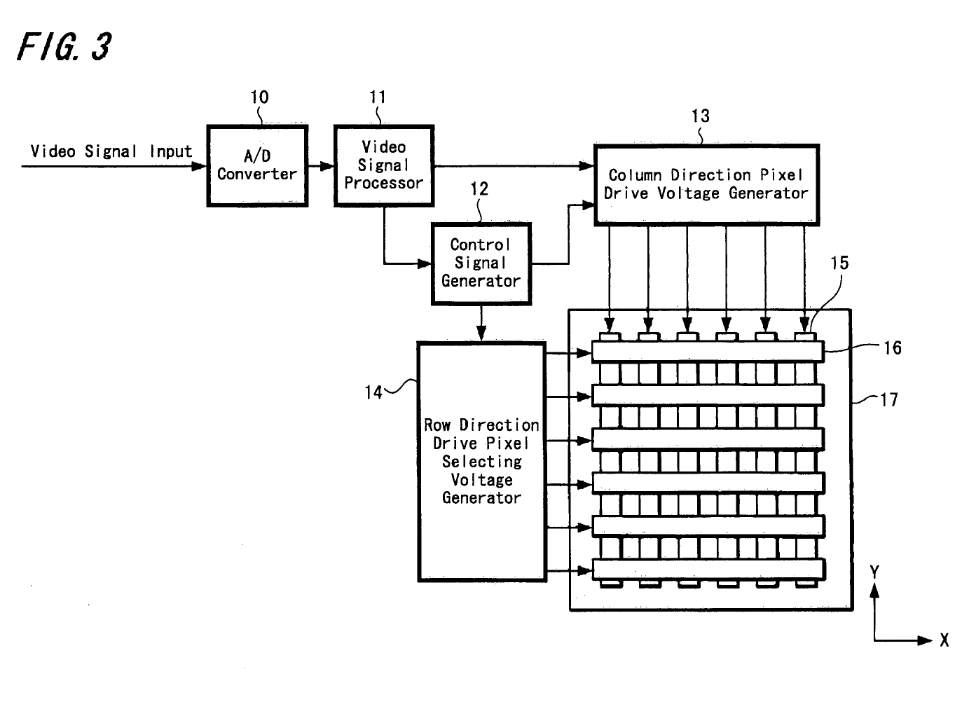

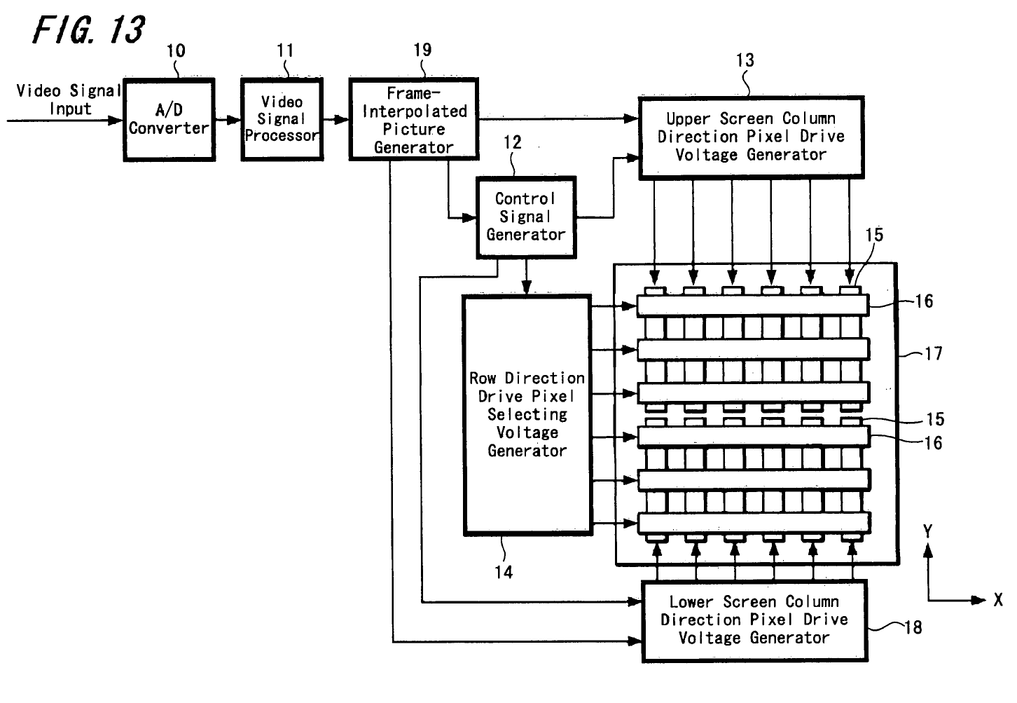

Hereinafter, an FED panel display system according to an embodiment of the present invention is specifically explained with reference to the drawings. FIG. 13 is a diagram showing an example of the structure of the FED panel display system according to an embodiment of the present invention, and portions in common with FIG. 3 are denoted by the same reference numerals.

A support body 17 is the support body (corresponding to the support body 313 in FIG. 1) constituting a cathode panel of an FED panel. A plurality of column direction wirings 15 and a plurality of row direction wirings 16 are formed on the support body 17, and gate electrodes, cathode electrodes and electron emission regions as shown in FIG. 1 exist at each intersection of the column direction wiring and the row direction wiring. (although not shown in the figure, the cathode panel is faced to an anode panel above as shown in FIG. 1).

Here, the column direction wirings are divided in two in the vertical direction at the center of a screen. Of the divided two sets, the column direction wirings 15 on the upper side are connected to an upper screen column direction pixel drive voltage generator 13, the column direction wirings 15 on the lower side 15 are connected to a lower screen column direction pixel drive voltage generator 18, and the row direction wirings 16 are connected to a row direction drive pixel selecting voltage generator 14 and thereby an FED module is constructed.

Further, FIG. 13 shows an example in which the input video is of an analogue signal, and which includes an A/D converter 10 that converts an analogue signal input to the FED panel display system to a digital signal, a video signal processor 11 to which the digital video signal from the A/D converter 10 is input, a frame-interpolated picture generator 19, and a control signal generator 12.

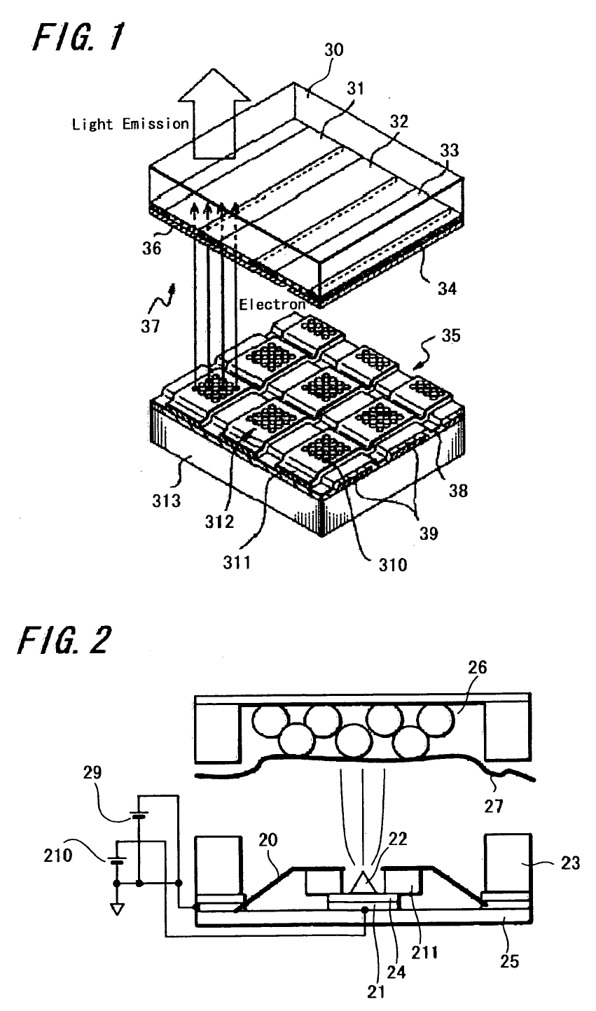

The row direction drive pixel selecting voltage generator 14 selectively applies a variable row direction selecting voltage Vrow (refer to FIG. 2) to the row direction wirings 16 and, for example, 35V is applied when selected and 0V is applied when not selected. This row direction drive pixel selecting voltage generator 14 can drive a plurality of rows simultaneously.

Though not shown in the figure, each of the upper screen column direction pixel drive voltage generator 13 and lower screen column direction pixel drive voltage generator 18 includes a shift register for inputting digital video signals (typically, the digital signal of R (Red), G (Green) and B (blue),) of one line (that is, of one horizontal period), a line memory for retaining the above described digital video signals for one line period, a D/A converter in which the above described video of one line is converted into analogue voltage to be applied for one line period, and the like; and a variable column direction drive voltage Vcol (refer to FIG. 2) for one line is simultaneously applied to the column direction wirings 15.

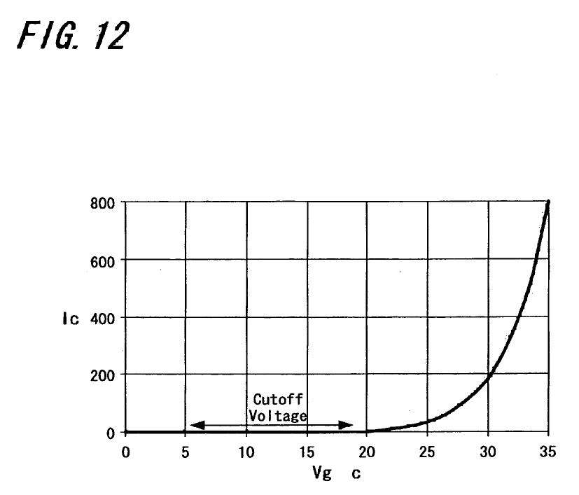

For example, when the row direction selection voltage Vrow is in the selected state, namely when 35V is applied, if the column direction drive voltage Vcol is 0V, the voltage difference Vgc between the gate and cathode becomes 35V, the amount of electrons emit from the cathode element 22 (refer to FIG. 2) increases, and luminance of the light emitted from the phosphors 26 (refer to FIG. 2) becomes high. Further, similarly when the row direction selection voltage Vrow is in the selected state, namely when 35V is applied and if the column direction drive voltage Vcol is 15V, the voltage difference Vgc between the gate and cathode becomes 20V, however, since electrons emitted has the characteristic of emission as shown in FIG. 12 with respect to Vgc, no electron is emitted when the Vgc is 20 v; consequently, no light emission occurs. Accordingly, the desirable luminance display can be performed by controlling the column direction drive voltage Vcol from 0V through 15V in accordance with the input video signal level.

In the case where the picture is displayed on the FED panel, the row direction wirings 16 are sequentially scanned by one line, and synchronously the modulated signals of the picture of one line is applied to the column direction wirings 15 simultaneously, so that the irradiation amount of electron beams to the phosphors is controlled and the picture is displayed by one line sequentially.

The video signal processor 11 applies picture quality adjustment processing and matrix processing to the digital video signal input from the A/D converter 10 and outputs a digital signal of 8-bit R, G and B, for example, and outputs a horizontal synchronous signal and vertical synchronous signal. These digital signal of R, G and B, horizontal synchronous signal and vertical synchronous signal are input to the frame-interpolated picture generator 19.

If one frame of the input video signal is 1/60 sec, the frame-interpolated picture generator 19 generates a video signal of 120 frames per second by interpolating this video signal between two frames of the front and back. In other words, the interpolated video signal in which the video signal is interpolated to have the frames doubled is generated. Further, from among the video signals generated with 120 frames per second, the frame-interpolated picture generator 19 outputs the picture data for the upper half screen to the upper screen column direction pixel drive voltage generator 13, and outputs the picture data for the lower half screen to the lower screen column direction pixel drive voltage generator 18.

Note that, there may be other cases included as embodiments than the above example, such as a case in which the frame-interpolated picture generator 19 generates a video signal by interpolation using movement detecting information, and a case in which the frame-interpolated picture generator 19 generates the video signal by interpolation based on signal processing that alters by the video sequence information a frame to be referenced, and the present invention is not limited to the above embodiment.

Further, a horizontal synchronous signal and vertical synchronous signal are output to the control signal generator 12, from the frame-interpolated picture generator 19.

Based on the horizontal synchronous signal and vertical synchronous signal, the control signal generator 12 generates: an upper screen column wiring drive circuit video acquisition start pulse and lower screen column wiring drive circuit video acquisition start pulse that indicate the video acquisition start timing in the upper screen column direction pixel drive voltage generator 13 and the video acquisition start timing in the lower screen column direction pixel drive voltage generator 18; and an upper screen column wiring drive start pulse and lower screen column wiring drive start pulse that indicate the timing of generating analogue video voltage in the D/A converter within the upper screen column direction pixel drive voltage generator 13 and lower screen column direction pixel drive voltage generator 18.

Furthermore, based on the horizontal synchronous signal and vertical synchronous signal, the control signal generator 12 generates: a row wiring drive start pulse that indicates the drive timing of row direction wiring drive voltage in the row direction drive pixel selecting voltage generator 14; and a row wiring selection shift clock that is a reference shift clock for sequentially driving the row direction wirings 16 from the top by one line in each of the upper and lower screens simultaneously.

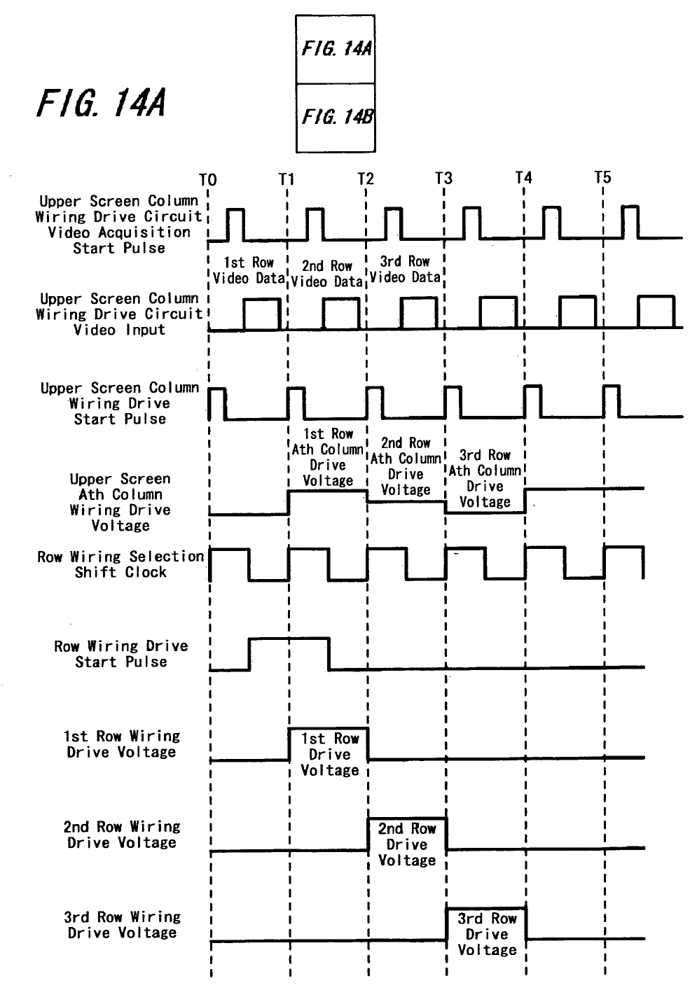

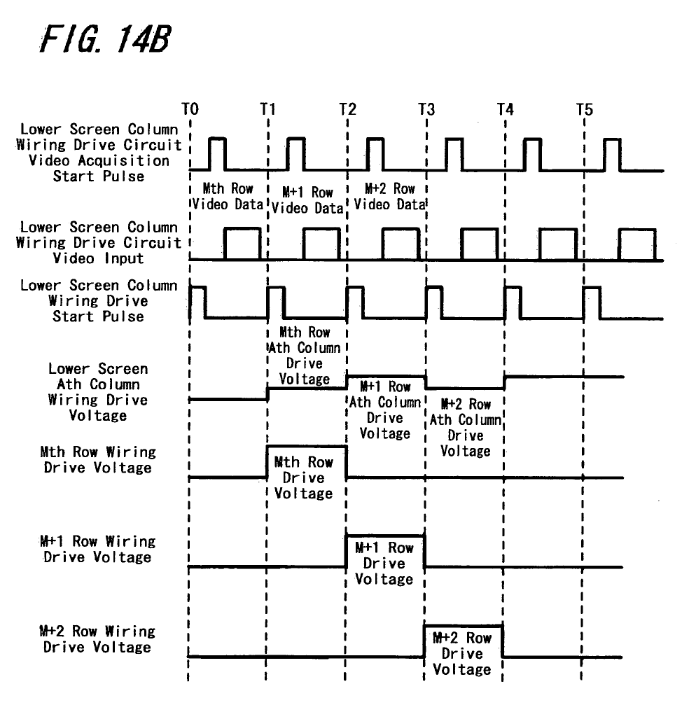

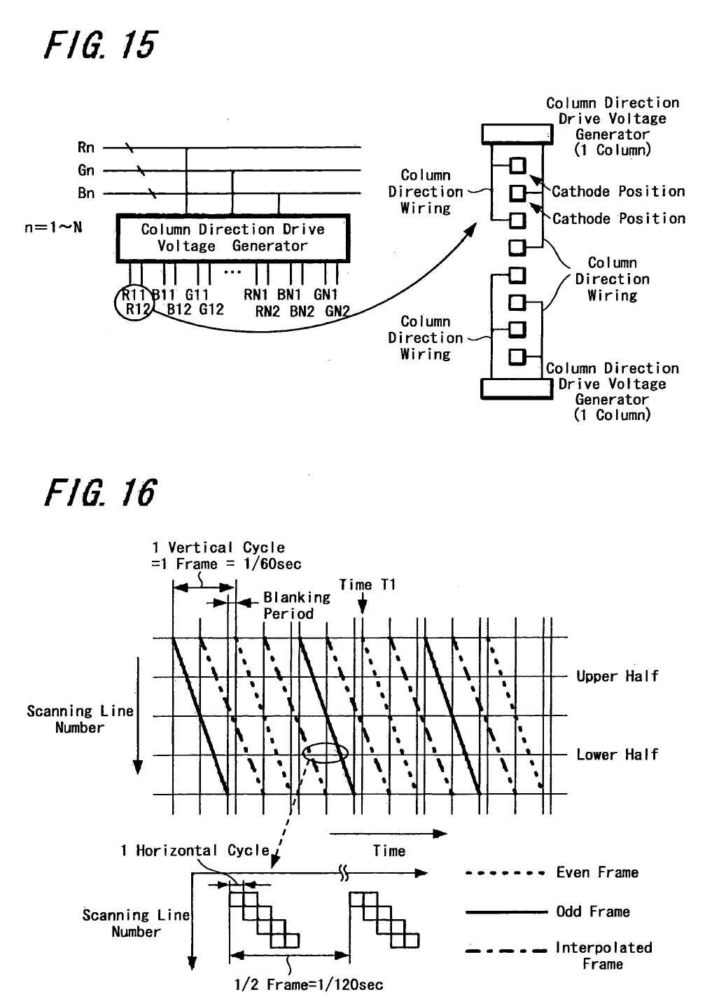

FIGS. 14A and 14B show drive timing of the FED panel in the FED panel display system of FIG. 13. Upper screen column wiring drive circuit video input is a digital signal of each 8-bits R, G and B and 24 bits in total, for example, input in parallel to the upper screen column direction pixel drive voltage generator 13 (refer to FIG. 13) and, though not shown in this figure, one pixel is sampled with a reference dot clock for digital video signal reproduction.

Lower screen column wiring drive circuit video input is a digital signal of each 8-bit R, G and B and 24 bits in total, for example, input in parallel to the lower screen column direction pixel drive voltage generator 18 (refer to FIG. 13) and, though not shown in this figure, one pixel is sampled with a reference dot clock for digital video signal reproduction.

The upper screen column direction pixel drive voltage generator 13 detects the above described upper screen column wiring drive circuit video acquisition start pulse immediately before the upper screen column wiring drive circuit video input (before one dot clock, for example) and, after that, acquires and holds the upper screen column wiring drive circuit video input into a shift register for pixels of one horizontal line sequentially stored synchronously with the dot clock. Further, synchronously with the above described upper screen column wiring drive start pulse detected after completing the acquisition of one line pixels, these one line video data are transferred to a line memory, and D/A conversion is performed by each pixel simultaneously on the held line video data to be output as the column wiring drive voltage of analog voltage, for example.

The lower screen column direction pixel drive voltage generator 18 detects the above described lower screen column wiring drive circuit video acquisition start pulse immediately before the lower screen column wiring drive circuit video input (before one dot clock, for example) and, after that, acquires and holds the lower screen column wiring drive circuit video input into a shift register for pixels of one horizontal line sequentially stored synchronously with the dot clock. Further, synchronously with the above described lower screen column wiring drive start pulse detected after completing the acquisition of one line pixels, these one line video data are transferred to a line memory, and D/A conversion is performed by each pixel simultaneously on the held line video data to be output as the column wiring drive voltage of analog voltage, for example.

FIGS. 14A and 14B show, as an example, the column wiring drive voltage for driving the Ath pixel in the horizontal direction represented as the Ath column wiring drive voltage, and furthermore, shows an example of the case in which the first row and the Mth row (uppermost row of the lower screen) at the center of the screen at the same time in one frame period.

The row direction drive pixel selecting voltage generator 14 detects the ON state of the above described row wiring drive start pulse on, for example, the rising edge of the row wiring drive start pulse and the row direction wirings 16 are sequentially driven (scanned) with the rising edge being made as a reference point, where as mentioned above, driving is performed to make two pulses exist in one frame without fail. In other words, one line in each of the upper and lower screen row direction wirings 16 is simultaneously driven from the top sequentially.

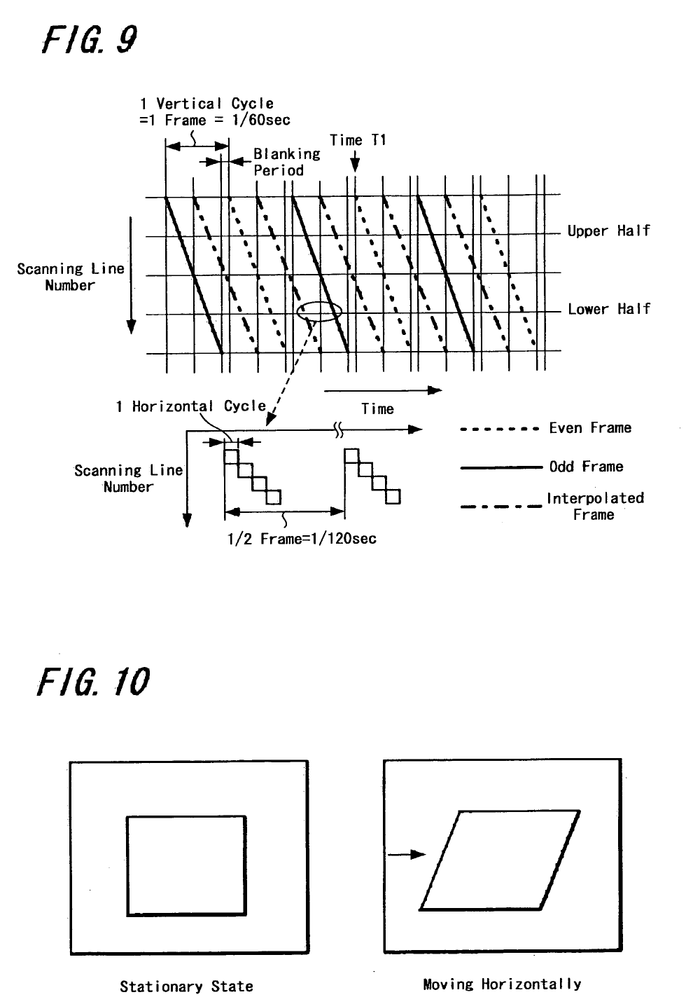

Next, in order to facilitate explanation, FIG. 9 shows an example in which the scanning timing in each line in the case where the panel is scanned by the above described method is illustrated with a macroscopic view. Time T1 in FIG. 9 and time T1 in FIGS. 14A and 14B show the same time. As shown in FIGS. 14A and 14B, the first row and the Mth row at the center of the screen are being scanned in time T1. Then, at the time T1 shown in FIG. 9, with respect to content of video data, in the 1st row is scanned the 1st line of an effective picture of an even frame of the input video signal; and in the Mth row is scanned the Mth line of an effective picture of the interpolated frame generated in the frame-interpolated picture generator 19 using the even frame and the previous odd frame (refer to FIG. 13).

Therefore, as shown in FIGS. 14A and 14B, in the Ath column line at this time, the above described voltage Vgc that is the difference voltage between the 1st row wiring drive voltage and the lower screen Ath column wiring drive voltage representing the 1st line Ath column of an effective picture of an even frame is applied between the gate and cathode, so that the electron beam emission occurs at the position of the 1st row Ath column and the phosphors above emit light; and the voltage Vgc that is the difference voltage between the Mth row wiring drive voltage and the upper screen Ath column wiring drive voltage that represents the Mth line Ath column of an effective picture of an interpolation frame is applied between the gate and cathode, so that the electron beam emission occurs at the position of the Mth row Ath column and, the phosphors above emit light.

Then, in the middle from time t1 through time T2, with respect to the content of each video data, in the 1st row, the 1st line of an effective picture of the interpolated frame generated by the frame-interpolated picture generator 19 (refer to FIG. 13) is scanned using this even frame and an subsequent odd frame, and in the Mth row, the Mth line of an effective picture of this even frame is scanned.

Similarly, at the time T2 in FIGS. 14A and 14B, the scanning on the 2nd row and M+1 row occur and the phosphors at above the positions of Ath column 2nd row and Ath column M+1 row emit light. On and after the time T3, the same action occurs in FIGS. 14A and 14B.

Here, although only the actions around time T1 in the example of the scanning timing of FIG. 9 has been explained, such two line simultaneous scanning using the interpolated frame continues periodically, as shown in FIG. 9. On driving the FED panel with such timing, the video scanning cycle in each line becomes ½ the original input video signal as shown in FIG. 9. In other words, if one frame cycle of the input video is 1/60 second, the scanning cycle per line of this scanning video becomes 1/120 second.

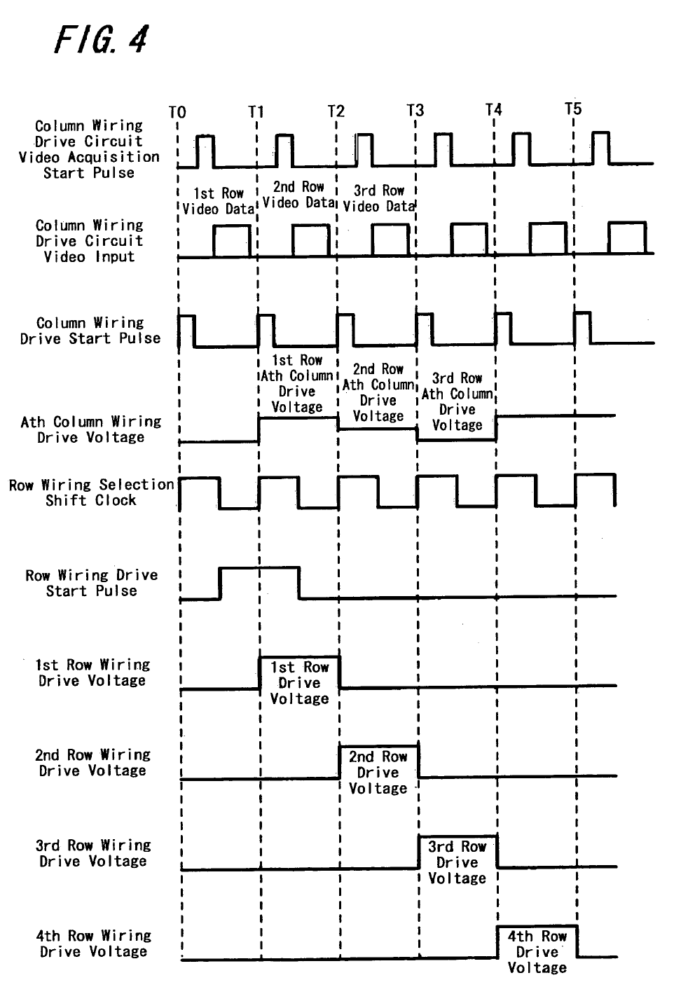

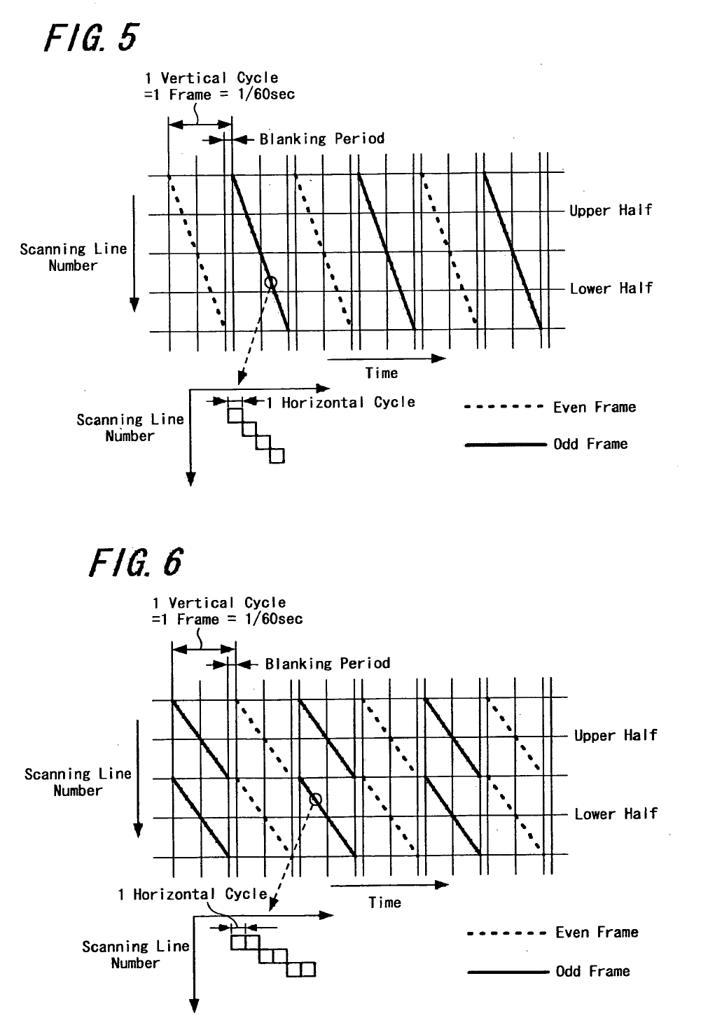

However, as shown in FIGS. 9, 14A and 14B, because the display period for one line of video signal scanning is the same as the horizontal period 1H of the input video signal, the 1H light emission occurs twice in terms of the vertical scanning period of the input video signal. In other words, it becomes equivalent to the fact that the light emission time is doubled, and the luminance becomes doubled in comparison with the case of the typical scanning timing (refer to FIGS. 4 and 5).

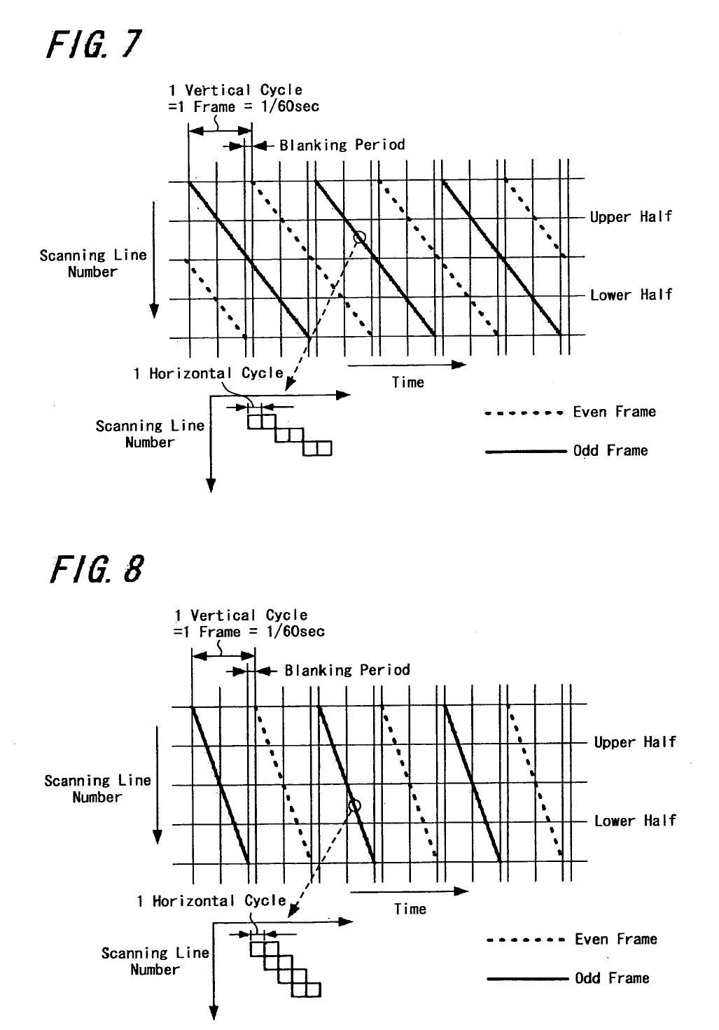

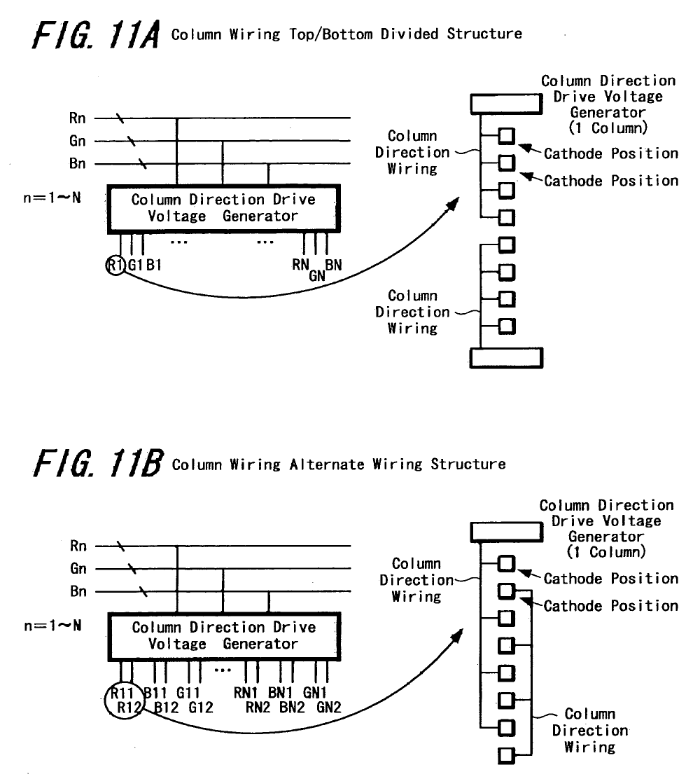

Further, when considering the picture quality, because the video scanning cycle for one screen corresponds with the vertical scanning period of the input video signal, such considerable distortion (refer to FIG. 10) as caused by the drive method of related art shown in FIG. 7 due to the mismatch between the input video cycle and the display timing cycle is prevented from occurring on the screen, and the feeling of discontinuity in the center of the screen of related art shown in FIG. 6 does not occur. Further, because the divided two sets of column direction wirings are driven by the interpolated video signal with a frame shifted by a ½ vertical cycle of the input video signal, no such discontinuity feeling in the center of the screen occurs when the moving picture is displayed as that in the drive method of related art shown in FIG. 6. Therefore, the high quality picture can be displayed.

Further, the wiring structure of the panel may be the one in which the column direction wirings are divided in the vertical direction, so that the panel design becomes physically easy in comparison with the case in which the panel column wirings are doubled in the horizontal direction, as shown in FIG. 11B.

Further, as a modified example of FIG. 13, the FED panel may have the wiring structure in which the panel column wirings are doubled in the horizontal direction and alternately wired to each row (the same structure as FIG. 11B), and the FED panel may be scanned with the timing as shown in FIG. 16. In this case, although the wiring structure in the column direction becomes complicated, the luminance theoretically increases four times without causing picture quality problems in comparison with a typical drive method (refer to FIG. 5).

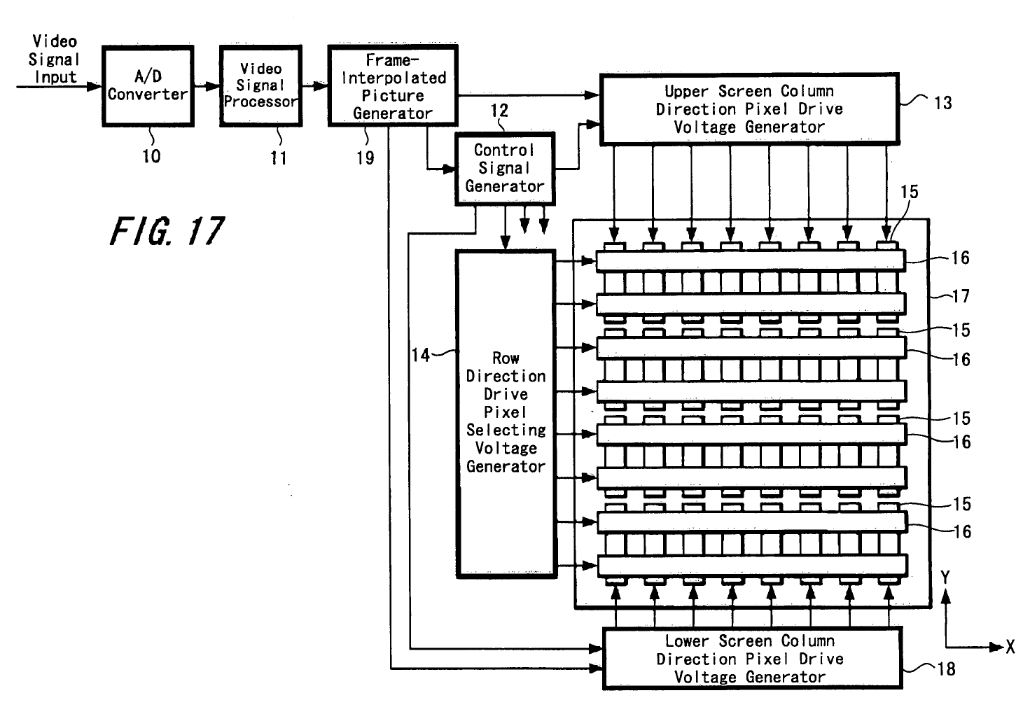

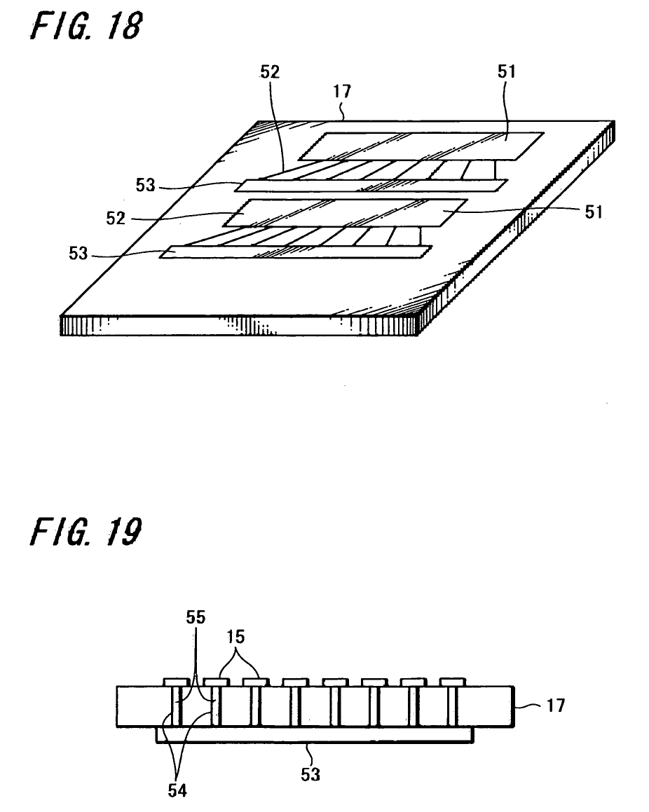

Further, although the example of an FED shown in FIG. 13 has a wiring structure in which the column direction wirings are divided in two in the vertical direction, the wiring structure may be the one in which the column direction wirings of the FED panel are divided into 3 or more in the vertical direction. FIGS. 17 through 19 are diagrams showing the modified examples of the column direction wiring structure of such an FED panel (FIGS. 18 and 19 are a rear side view and sectional view of an FED panel) and portions in common with those in FIG. 13 are denoted by the same reference numerals.

In this modified example, the column direction wirings 15 are equally divided into four in the vertical direction. As shown in FIG. 17, the uppermost column direction wirings 15 among the divided four sets are connected to the upper screen column direction pixel drive voltage generator 13 and the bottom column direction wirings 15 are connected to the lower screen column direction pixel drive voltage generator 18. Further, as shown in FIG. 18, two mid-screen column direction pixel drive voltage generators 51 that generate the drive voltage supplied to the remaining two sets of the column direction wirings 15 in the center are connected to connectors 53 respectively by the FPC (flexible print cable) circuit board 52 on the rear surface of the support body 17 of the FED panel.

As shown in FIG. 19, through-holes 54 are bored at each wiring position of two sets of column direction wirings 15 in the middle, and the wirings 55 connecting connectors 53 and those individual wirings are formed in these through-holes.

The applicant of the present invention have already proposed in Japanese Patent Application No. 2000-11992 (Published Japanese Patent Application No. 2000-298446) the display device having the rear surface wiring structure as shown in FIGS. 18 and 19 of the present invention.

In this modified example, if one frame of the input video signal is 1/60 second for example, the frame-interpolated picture generator 19 generates the video signal of 240 frames per second, by generating three interpolated frames from two previous and subsequent frames of the video signal. In other words, the interpolated video signal in which the video signal is interpolated to have the frame interpolation of four times is generated. Further, among the generated video signals of 240 frames per second, the frame-interpolated picture generator 19 outputs the picture data of the uppermost screen to the upper screen column direction pixel drive voltage generator 13, and outputs picture data of two mid screens to the mid-screen column direction pixel drive voltage generators 51 (FIG. 18) respectively, and outputs the picture data of the bottom screen to the lower screen column direction pixel drive voltage generator 18.

Further, the control signal generator 12 generates a row wiring selection shift clock that is a reference shift clock for simultaneously driving the row wiring 16 in each of the uppermost screen, two mid screens and bottom screen by one line sequentially from the top. Therefore, the row direction drive pixel selecting voltage generator 14 drives the 1st row, the uppermost rows of two middle screens and the uppermost row of the bottom screen simultaneously in one frame period.

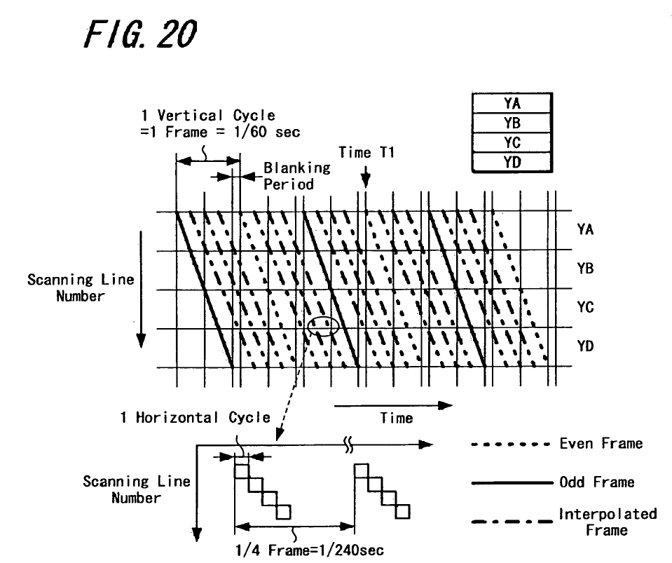

FIG. 20 shows an example in which the scanning timing in each line in this modified example is illustrated with a macroscopic view similarly to FIG. 9, where YA denotes the upper screen; YB and YC denote two middle screens; and YD denotes the lower screen. Time T1 is the time when the 1st row (uppermost row of the upper screen), the uppermost row (termed M1 row, M2 row) of two middle screens YB, YC and the uppermost row (termed M3 row) of the lower screen YD are being scanned, and at this time T1, with respect to the content of each video data, in the 1st row, the 1st line of an effective picture of an even frame of the input video signal is scanned and, in the uppermost rows of screens YB, YC and YD, the M1, M2 and M3 lines of effective pictures of the 1st, 2nd and 3rd interpolated frames generated in the frame-interpolated picture generator 19 (refer to FIG. 13) using the even frame and the previous odd frame, respectively are scanned.

In the case of this modified example, because the wiring structure of the panel may be the one in which the column direction wirings are divided in the vertical direction, the design becomes physically easy, and the luminance theoretically increases four times without causing picture quality problems in comparison with a typical drive method (refer to FIG. 5).

Further, although the vertical scanning cycle of the input video signal is 1/60 second in the embodiments above, another arbitrary cycle than this cycle can also be used to obtain similar results and similar effects, and needless to say those are within the scope of the present invention.

Further, in the embodiments above, although the level of luminance is altered in accordance with the voltage level between the gate and cathode, in the case where the present invention is applied to a pulse drive method in which gradation is expressed based on the period of time when the voltage is applied between the gate and cathode after the voltage level between the gate and cathode is made constant, similar procedures are easily employed and obviously such case is within the scope of this invention.

Further, with respect to the drive method according to an embodiment of the present invention, although the explanation has been made regarding the FED panel display, theoretically this invention can sufficiently be applied to a matrix type flat panel display (an organic EL display, for example) that employs other similar pixel drive methods and needless to say the present invention can be applied to those devices.

While the Invention has been described with reference to specific embodiments chosen for purpose of illustration, it should be apparent that numerous modification could be made thereto by those skilled in the art without departing from the basic concept and scope of the invention.

What is claimed is:

1. A display module comprising:
a display panel in which column direction wirings and row direction wirings are formed perpendicularly to each other and said column direction wirings are divided into N sets (N is an integer of 2 or more) in the vertical direction of a screen;
drive means for driving each of said N sets of said column direction wirings; and
scanning means for scanning said row direction wirings,
wherein said scanning means simultaneously scan said row direction wirings corresponding to said N sets of said column direction wirings respectively with approximately 1/N the vertical cycle of a video signal, and
said drive means, to which an interpolated video signal that is said video signal frame-interpolated N times is input, drive each of said N sets of said column direction wirings by said interpolated video signal with a frame shifted by 1/N the vertical cycle of said video signal.

2. The display module according to claim 1,
wherein said column direction wirings in said display panel are divided in two in the vertical direction of a screen.

3. The display module according to claim 1,
wherein said column direction wirings in said display panel are divided into three or more in the vertical direction of a screen and,
on the rear side of said display panel are wired said drive means and other column direction wirings than those of the upper end and lower end of the screen among said three or more sets of column direction wirings.

4. The display module according to claim 1,
wherein said display panel is an FED panel.

5. The display module according to claim 1,
wherein said display panel is an organic EL panel.

6. A drive method of a display panel in which column direction wirings and row direction wirings are formed perpendicularly to each other and said column direction wirings are divided into N sets (N is an integer of 2 or more) in the vertical direction of a screen, comprising the steps of:
generating an interpolated video signal that is a video signal frame-interpolated N times,
simultaneously scanning said row direction wirings corresponding to N sets of said column direction wirings respectively with approximately 1/N the vertical cycle of said video signal, and
driving each of said N sets of said column direction wirings by an interpolated video signal with a frame shifted by 1/N the vertical cycle of said video signal among said interpolated video signals that are said video signals frame-interpolated N times.

7. A display device comprising:
a display panel in which column direction wirings and row direction wirings are formed perpendicularly to each other and said column direction wirings are divided into N sets (N is an integer of 2 or more) in the vertical direction of a screen;
drive means for driving each of said N sets of said column direction wirings;
scanning means for scanning said row direction wirings,
interpolation means for interpolating a frame of said input video signal said N times,
wherein said scanning means simultaneously scans said row direction wirings corresponding to said N sets of said column direction wirings respectively with approximately 1/N the vertical cycle of said input video signal, and
said drive means, to which an interpolated video signal is input from said interpolation means, drives each of said N sets of said column direction wirings by said interpolated video signal with a frame shifted by 1/N the vertical cycle of said input video signal.

8. The display device according to claim 1,
wherein said column direction wirings in said display panel are divided in two in the vertical direction of a screen.

9. The display device according to claim 7,
wherein said column direction wirings in said display panel are divided into three or more in the vertical direction of a screen, and
on the rear side of said display panel are wired said drive means and other column direction wirings than those of the upper end and lower end of the screen among said three or more sets of column direction wirings.

10. The display device according to claim 7,
wherein said display panel is an FED panel.

11. The display device according to claim 7,
wherein said display panel is an organic EL panel.
